(19) United States
(12) Patent Application Publication
(10) Pub. No.: US 2015/0178193 A1
(43) Pub. Date: Jun. 25, 2015

(54) APPARATUS AND METHOD FOR MANAGING FLASH MEMORY BY MEANS OF WRITING DATA PATTERN RECOGNITION

(71) Applicant: INDUSTRY-UNIVERSITY COOPERTATION FOUNDATION, HANYANG UNIVERSITY, Seoul (KR)

(72) Inventors: Yong-Ho Song, Seoul (KR); Sang-Hyuk Jung, Seoul (KR)

(73) Assignee: INDUSTRY-UNIVERSITY COOPERATION FOUNDATION, HANYANG UNIVERSITY, Seoul (KR)

(21) Appl. No.: 14/413,997

(22) PCT Filed: Jul. 11, 2012
(86) PCT No.: PCT/KR2012/005491

§ 371 Date: Jan. 9, 2015

(51) Int. Cl. G06F 12/02

(52) U.S. Cl. CPC G06F 12/0246; G06F 2212/7201

(57) ABSTRACT

An apparatus and method for managing flash memory based on recognition of patterns of write-target data are disclosed. A data analysis unit analyzes bit storage patterns that are stored in cells of the flash memory, and a data matching unit matches corresponding alternative patterns to the bit storage patterns based on the results of the analysis of the data analysis unit. According to the present invention, the reliability and durability of NAND flash memory can be improved because a minimum number of “0” bits are stored in a page. Furthermore, the application of the technology is easy and simple because a memory controller can perform management without changes in the structure and cell arrangement of a NAND flash device.

### CROSS-REFERENCE TO RELATED APPLICATION

This application is the National Stage of International Application No. PCT/KR2012/005491 filed on Jul. 11, 2012.

### TECHNICAL FIELD

The present invention relates generally to an apparatus and method for managing flash memory and, more particularly, to an apparatus and method for managing flash memory, which are capable of improving the reliability and durability of the flash memory.

### BACKGROUND ART

Flash memory is being widely used in portable devices, such as digital cameras, Moving Picture Experts Group Layer-3 (MP3) players, mobile phones and Personal Digital Assistants (PDAs), thanks to advantages, such as low power and small size. Recently, as the capacity of flash memory has considerably increased, flash memory has reached the point at which it can replace the hard disk storage devices of personal computers or server computers.

Flash memory performs an erase-before-write operation because of the intrinsic physical characteristics thereof. In flash memory, if data has been already stored in a page when a write operation is performed on the page, the write operation can be performed after the block to which the page belongs has been erased. Flash memory requires a longer time to perform a write operation because it does not support overwriting unlike a hard disk Overwriting additionally generates garbage collection and a merge operation, and rapidly increases the write amplification factor. Furthermore, repeatedly performing an erase operation on a specific block should be avoided because each block of flash memory cannot be used any longer after a number of erase operations equal to or larger than a specific number have been performed on the block.

Since NAND flash memory is more expensive than a hard disk per capacity, the technique of increasing the level of integration of cells and the technique of increasing the number of bits that can be stored in each cell are employed in order to increase cost competitiveness. Although these techniques have contributed to a reduction in the cost of NAND flash devices, the durability and reliability of NAND flash memory have been significantly reduced.

NAND flash memory has a gate structure that manages electrons on a cell basis. The gates thereof are composed of two gates, that is, a control gate and a floating gate. Data is stored in such a way that a thin oxide layer between the two gates retains and emits an electron. However, the gates are bound to a single word line, and thus there occurs the characteristic that the durability varies with the block Accordingly, in order to improve the reliability and durability of NAND flash memory, program/erase cycles should be managed on a block basis. Furthermore, a method capable of reducing the migration of electrons per cell in a more detailed manner should be presented.

A conventional method is a cell to cell interference cancellation technique. In order to change the cell bit pattern of NAND flash memory, a voltage equal to or higher than a specific voltage should be applied. The application of such a high voltage exerts the influence resulting from the variation in voltage not only on a specific cell whose bit pattern needs to be changed but also on the other cells which belong to the same word line as the specific cell. Although the bit patterns of the adjacent cells can operate without error only when a constant voltage is maintained, a problem arises in that the durability and reliability of NAND flash memory are deteriorated because of an inter-cell signal noise problem. In order to overcome this problem, a cell to cell interference cancellation technique is used to detect the voltages of the adjacent cells and apply a voltage from which signal noise has been removed to the specific cell. This technique reduces the influence resulting from the variation in voltage that will be exerted on the eight adjacent cells. This technique improves the reliability and the durability up to two times, but the complexity is increased to perform computation that is required to apply the voltage.

Another conventional method is a randomization technique. This technique reduces the influence that will be exerted on all cells that belong to the same word line. Although the reliability and durability of NAND flash memory are fixed on a block basis, the problem that the durability is significantly deteriorated by a cell-based bit storage pattern occurs in the worst case. When a “0” bit is repeatedly stored in a specific cell in a single word line, the durability of an overall block is deteriorated. In order to overcome this problem, a technique is used to randomly convert the data stored in a page basis and to store it. In this case, the worst situation can be avoided. However, the durability is fixed to an average value, and complicated computation is required to restore data using a seed value.

As described above, the reliability and durability of next generation NAND flash memory that has been recently marketed are considerably lower than the reliability and durability of conventional flash memory, and also the conventional cell to cell interference cancellation technique and the conventional randomization technique cannot significantly improve the durability and reliability.

### DISCLOSURE

### Technical Problem

An object of the present invention is to provide an apparatus and method for managing flash memory, which are capable of improving the reliability and durability of flash memory.

Another object of the present invention is to provide a computer-readable storage medium that stores a program that can execute, on a computer, a method of managing flash memory, which is capable of improving the reliability and durability of flash memory.

### Technical Solution

In order to accomplish the above objects, the present invention provides an apparatus for managing flash memory, including a data analysis unit configured to analyze bit storage patterns that are stored in cells of the flash memory; and a data matching unit configured to match corresponding alternative patterns to the bit storage patterns based on the results of the analysis of the data analysis unit

In order to accomplish the above objects, the present invention provides a method of managing flash memory, including a data analysis step of analyzing bit storage patterns that are stored in cells of the flash memory; and a data matching step of matching corresponding alternative patterns to the bit storage patterns based on the results of the analysis at the data analysis step.

In order to accomplish the above objects, the present invention provides an apparatus for managing flash memory, including a data analysis unit configured to analyze bit storage patterns that are stored in cells of the flash memory; and a data matching unit configured to generate alternative patterns that match the bit storage patterns, respectively, based on the results of the analysis of the data analysis unit.

### Advantageous Effects

In accordance with an apparatus and method for managing flash memory based on the recognition of the patterns of write-target data according to the present invention, the reliability and durability of NAND flash memory can be improved because a minimum number of “0” bits are stored in a page. Furthermore, the application of the technology is easy and simple because a memory controller can perform management without changes in the structure and cell arrangement of a NAND flash device.

### DESCRIPTION OF DRAWINGS

FIG. 1 is a block diagram showing the configuration of an apparatus for managing flash memory based on the recognition of the patterns of write-target data according to an embodiment of the present invention;

FIG. 2 is a block diagram showing the configuration of the location of the apparatus for managing flash memory based on the recognition of the patterns of write-target data in an overall system according to an embodiment of the present invention;

FIG. 3 is a diagram showing the case of recognizing the bit storage pattern of write-target data and matching the bit storage pattern to an alternative pattern; and

FIG. 4 is a flowchart showing the operation of the apparatus for managing flash memory based on the recognition of the patterns of write-target data according to an embodiment of the present invention.

### BEST MODE

An apparatus and method for managing flash memory based on the recognition of the patterns of write-target data according to embodiments of the present invention will be described in detail below with reference to the accompanying drawings.

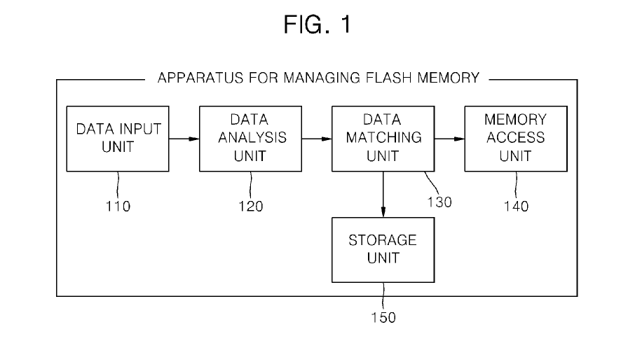

FIG. 1 is a block diagram showing the configuration of an apparatus for managing flash memory based on the recognition of the patterns of write-target data according to an embodiment of the present invention.

Referring to FIG. 1, the apparatus for managing flash memory according to the present invention includes a data input unit 110, a data analysis unit 120, a data matching unit 130, a memory access unit 140, and a storage unit 150.

Write-target data based on a write request from the outside is input to the data input unit 110.

The data analysis unit 120 analyzes bit storage patterns in which the write-target data input based on the write request is stored in cells of the flash memory. An example of an analysis method may be an analysis method based on the computation of the numbers of repetitions of the bit storage patterns in which write-target data is stored in cells of the flash memory.

The data matching unit 130 matches a corresponding alternative pattern to each of the bit storage patterns in which the write-target data is stored in the cells of the flash memory. For example, the data matching unit 130 may determine an alternative pattern so that the number of “1” bits included in the alternative pattern increases in proportion to the number of repetitions of each bit storage pattern. More specifically, if the number of repetitions of the bit storage pattern “0100” is the largest of those of all bit storage patterns, an alternative pattern corresponding to the bit storage pattern “0100” may be determined to be “1111.” Furthermore, if the number of repetitions of the bit storage pattern “0001” is the second largest of those of the bit storage patterns, the bit storage pattern “0001” may be matched to any one of the alternative patterns “1110,” “1101,” “1011” and “0111.”

The data matching unit 130 arranges the corresponding alternative patterns, matched to the respective bit storage patterns, in the form of an alternative pattern matching table, and the storage unit 150 stores the alternative pattern matching table generated by the data matching unit 130. The size of the alternative pattern matching table may be adjusted depending on the capacity of memory. That is, it is not necessary to determine alternative patterns for all bit storage patterns, but it may be possible to determine alternative patterns only for bit storage patterns, each of the numbers of repetitions of which is equal to or larger than a predetermined number.

Meanwhile, the data matching unit 130 may determine alternative patterns by analyzing the numbers of repetitions of bit storage patterns as described above, or may use preset alternative patterns based on the forms of bit storage patterns. Here, a table in which bit storage patterns have been matched to alternative patterns or a function which can obtain an alternative pattern based on the form of each bit storage pattern is stored in the storage unit 150 in advance, and the data matching unit 130 determines an alternative pattern for each bit storage pattern while referring to the data stored in the storage unit 150.

Finally, the memory access unit 140 stores the matched alternative patterns in the storage space of the flash memory.

Thereafter, if a request for reading the stored write-target data is input from the outside, the apparatus for managing flash memory according to the present invention may generate a bit storage pattern from each alternative pattern using the alternative pattern matching table or function stored in the storage unit 150.

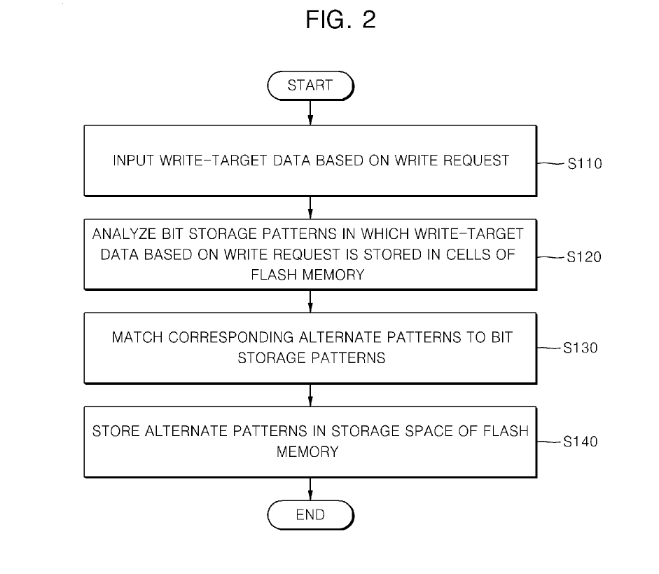

FIG. 2 is a block diagram showing the configuration of the location of the apparatus for managing flash memory based on the recognition of the patterns of write-target data in an overall system according to an embodiment of the present invention.

Referring to FIG. 2, a write/read command issued by a host reaches a flash translation layer via the command queue of a NAND flash memory-based storage device. In contrast, requested write-target data is temporarily stored in the buffer of the NAND flash memory-based storage device, and a flash program operation is performed after the requested write-target data has been mapped to an actual NAND area by the flash translation layer.

The apparatus for managing flash memory based on the recognition of the patterns of write-target data according to the present invention is implemented in a control layer on which a flash program is running in the form of a data pattern recognition memory access engine, and performs the encoding/decoding of data patterns. If a controller is located inside a NAND flash memory device, the apparatus for managing flash memory based on the recognition of the patterns of write-target data according to this embodiment of the present invention may be located inside the controller of a corresponding chip. Alternatively, the data pattern recognition memory access engine may be implemented as a hardware module, or the alternative pattern matching table referred to by the engine may be placed in Static Random Access Memory (SRAM).

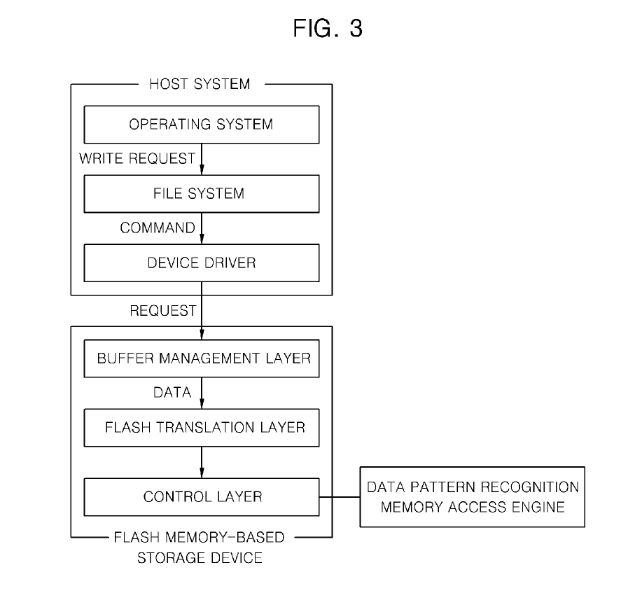

FIG. 3 is a diagram showing the case of recognizing the bit storage pattern of write-target data and matching the bit storage pattern to an alternative pattern. As described above, the alternative pattern matching table is present in the storage unit 150 inside a data pattern recognition memory access engine The data matching unit 130 maps bit storage patterns to alternative patterns that will be actually stored, in a one-to-one correspondence. An extended Huffman algorithm may be used as a technique for generating alternative patterns that are actually stored in a flash area.

Although Huffman coding is designed to perform coding such that a more frequent data pattern has a shorter code, the present invention is designed such that a more frequent data pattern corresponds to a pattern having more “1” bits. Furthermore, for stored data whose number of “0” bits is excessively large even when a related bit storage pattern is not frequent, overhead is minimized by using a technique, such as inversion. In this case, simple information, such as inversion flag bits, is prompted to be stored in the spare area of the NAND flash memory.

As described above, the size of the alternative pattern matching table may be adjusted depending on the size of the memory, and alternative patterns may be represented in the form of a function related to bit storage patterns instead of being stored in the form of a table.

Another analysis method of analyzing write-target data based on a write request is an analysis method based on the computation of the numbers of “0” bits included in data patterns in which write-target data is stored in the pages of flash memory.

When write-target data is stored using the above analysis method, the data matching unit 130 may allow the memory access unit 140 to invert bits included in data patterns and then store the resulting data if the number of “0” bits in each of the data patterns in which the write-target data is stored in pages of flash memory is equal to or higher than a preset threshold value. In a typical case, the metadata of a file system has a data pattern in which the number of “0” bits is large. The reason for this is that a method is employed that uses a necessary portion and fills in the entire remaining reserved area with “0” bits because the metadata is used to store the map table of the overall data of the file system and set registers.

In light of the above characteristic, a technique of inverting bits in an overall page to be stored is very useful when there occurs a data pattern that causes a number of “0” bits equal to or larger than a preset threshold value to be stored. That is, when the number of “0” bits included in a data pattern to be stored in a page is equal to or larger than the preset threshold value, a “0” bit is converted into a “1” bit and a “1” bit is converted into “0” bit. When a page is stored, inversion flag bits representative of inversion or no inversion may be added by storing “1” bits or “0” bits in a spare area.

Still another method is an analysis method of determining whether consecutive “0” bits have been included in data patterns in which write-target data is stored in pages of flash memory. If, as a result of the analysis, consecutive “0” bits have been included in data patterns in which write-target data is stored in pages of flash memory, the data matching unit 130 of the apparatus for managing flash memory according to the present invention may allow the memory access unit 140 to invert the “0” bits and store the resulting data in the flash memory. That is, the apparatus for managing flash memory according to the present invention performs encoding so that a pattern having a larger number of “1” bits is obtained while sequentially scanning a data pattern to be stored. Although the bits of encoded data may be all “0” bits if the inversion of “1” and “0” bits is sustained in the worst case, the number of “1” bits may be increased by additionally using the above-described overall page bit inversion technique.

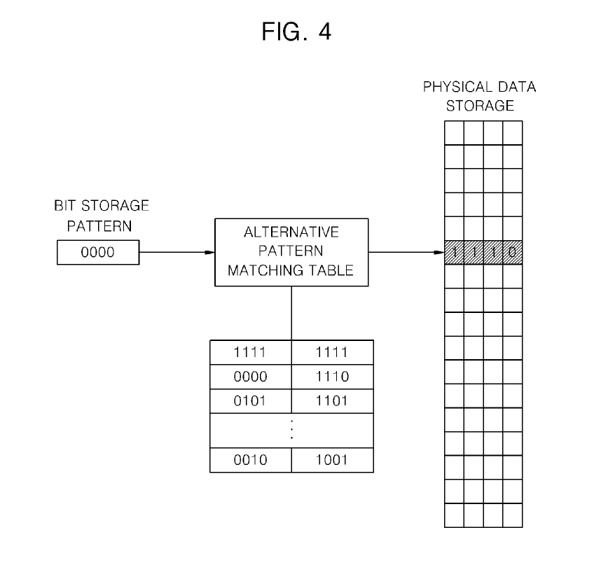

FIG. 4 is a flowchart showing the operation of the apparatus for managing flash memory based on the recognition of the patterns of write-target data according to an embodiment of the present invention.

Write-target data based on a write request from the outside is input to the data input unit 110 at step S110.

The data analysis unit 120 analyzes bit storage patterns in which the write-target data input based on the write request is stored in cells of the flash memory at step S120. An example of an analysis method may be an analysis method based on the computation of the numbers of repetitions of the bit storage patterns in which write-target data is stored in cells of the flash memory as described above.

The data matching unit 130 matches a corresponding alternative pattern to each of the bit storage patterns in which the write-target data is stored in the cells of the flash memory at step S130. The alternative pattern may be determined such that the number of “1” bits included in the alternative pattern increases in proportion to the number of repetitions of the bit storage pattern.

The alternative pattern matching table in which the bit storage patterns or data patterns and alternative patterns have been recorded together is stored in the storage unit 150. The size of the alternative pattern matching table may be adjusted depending on the capacity of the memory.

Finally, the memory access unit 140 stores the matched alternative pattern in the storage space of the flash memory at step S140.

As described above, the present invention uses the method of intentionally maximizing the number of “1” bits and storing the “1” bits in NAND flash memory, and therefore the NAND flash memory according to the present invention can improve reliability and durability 10 times than conventional NAND flash memory.

Furthermore, when write-target data is stored using the method of managing flash memory according to the present invention, a method may be used that separately stores different bits between the pattern of existing data already stored at a storage location corresponding to the address of flash memory at which the write-target data will be stored and a pattern obtained by the conversion of the write-target data according to the present invention. The reason for this is that the present invention may be implemented without making any change to the structure of a flash memory device.

More specifically, differential value data representative of the bits different from the existing data may be computed by performing an XOR operation on the pattern of the existing data and the pattern obtained by the conversion, and then the differential value data may be compressed and stored in a separate storage medium.

The present invention may be implemented in a computer-readable storage medium in the form of computer-readable code. The computer-readable storage medium includes all types of storage devices in which computer system-readable data is stored. Examples of the computer-readable storage medium are Read Only Memory (ROM), Random Access Memory (RAM), Compact Disk-Read Only Memory (CD-ROM), magnetic tape, a floppy disk, and an optical data storage device. Furthermore, the computer-readable storage medium may be implemented in the form of carrier waves (for example, in the case of transmission over the Internet). Moreover, the computer-readable medium may be distributed across computer systems connected via a network, so that computer-readable code can be stored and executed in a distributed manner.

Although the preferred embodiments of the present invention have been illustrated and described, the present invention is not limited to the preferred embodiments, but those skilled in the art will appreciate that various modifications are possible without departing from the scope and spirit of the invention. Furthermore, these modifications will fall within the scope of the accompanying claims.

1. An apparatus for managing flash memory, comprising:
a data analysis unit configured to analyze bit storage patterns that are stored in cells of the flash memory; and
a data matching unit configured to match corresponding alternative patterns to the bit storage patterns based on results of the analysis of the data analysis unit.

2. The apparatus of claim 1, further comprising a storage unit configured such that the alternative patterns corresponding to the bit storage patterns have been stored in advance in a form of a table or a function related to the bit storage patterns;
wherein the data matching unit matches the alternative patterns stored in the storage unit to the bit storage patterns.

3. The apparatus of claim 1, wherein:
the data analysis unit analyzes numbers of repetitions of the bit storage patterns in which the write-target data is stored in the cells of the flash memory; and
the data matching unit determines the alternative patterns so that a number of “1” bits included in each of the alternative patterns increases in proportion to a number of repetitions of a corresponding bit storage pattern.

4. The apparatus of claim 3, further comprising a storage unit configured to store the alternative patterns that have been determined for the respective bit storage patterns of the write-target data.

5. The apparatus of claim 1, wherein the data matching unit inverts bits included in data patterns if a number of “0” bits that is included in each of the data patterns in which the write-target data, which is stored in the cells of the flash memory in the bit storage patterns, is stored in pages of the flash memory is equal to or larger than a preset threshold.

6. The apparatus of claim 1, wherein the data matching unit inverts consecutive “0” bits if the consecutive “0” bits are included in each of the data patterns in which the write-target data, which is stored in the cells of the flash memory in the bit storage patterns, is stored in pages of the flash memory.

7. The apparatus of claim 5, further comprising a memory access unit configured to store the alternative patterns in the flash memory;
wherein the memory access unit stores inversion flag bits in a spare area of the flash memory if the inverted bits are stored in a storage space of the flash memory.

8. A method of managing flash memory, comprising:
a data analysis step of analyzing bit storage patterns that are stored in cells of the flash memory; and
a data matching step of matching corresponding alternative patterns to the bit storage patterns based on results of the analysis at the data analysis step.

9. The method of claim 8, wherein:
the alternative patterns corresponding to the bit storage patterns have been stored in advance in a form of a table or a function related to the bit storage patterns; and
the data matching step comprises matching the alternative patterns stored in advance to the bit storage patterns.

10. The method of claim 8, wherein:
the data analysis step comprises analyzing numbers of repetitions of the bit storage patterns in which the write-target data is stored in the cells of the flash memory; and
the data matching step comprises determining the alternative patterns so that a number of “1” bits included in each of the alternative patterns increases in proportion to a number of repetitions of a corresponding bit storage pattern.

11. The method of claim 10, further comprising a storage step of storing the alternative patterns that have been determined for the respective bit storage patterns of the write-target data.

12. The method of claim 8, wherein the data matching step comprises inverting bits included in data patterns if a number of “0” bits that is included in each of the data patterns in which the write-target data, which is stored in the cells of the flash memory in the bit storage patterns, is stored in pages of the flash memory is equal to or larger than a preset threshold.

13. The method of claim 8, wherein the data matching step comprises inverting consecutive “0” bits if the consecutive “0” bits are included in each of the data patterns in which the write-target data, which is stored in the cells of the flash memory in the bit storage patterns, is stored in pages of the flash memory.

14. The method of claim 12, further comprising a memory access step of storing the alternative patterns in the flash memory;
wherein the memory access step comprises storing inversion flag bits in a spare area of the flash memory if the inverted bits are stored in a storage space of the flash memory.

15. A computer-readable storage medium storing a program configured to execute, on a computer, the method of managing flash memory set forth in claim 8.

16. An apparatus for managing flash memory, comprising:
a data analysis unit configured to analyze bit storage patterns that are stored in cells of the flash memory; and
a data matching unit configured to generate alternative patterns that match the bit storage patterns, respectively, based on results of the analysis of the data analysis unit.

17. The apparatus of claim 16, wherein:
the data analysis unit analyzes numbers of repetitions of the bit storage patterns in which the write-target data is stored in the cells of the flash memory; and
the data matching unit generates the alternative patterns so that a number of “1” bits included in each of the alternative patterns increases in proportion to a number of repetitions of a corresponding bit storage pattern.

18. The apparatus of claim 16, wherein the data matching unit inverts bits included in data patterns if a number of “0” bits that is included in each of the data patterns in which the write-target data, which is stored in the cells of the flash memory in the bit storage patterns, is stored in pages of the flash memory is equal to or larger than a preset threshold.

19. The apparatus of claim 16, wherein the data matching unit inverts consecutive “0” bits if the consecutive “0” bits are included in each of the data patterns in which the write-target data, which is stored in the cells of the flash memory in the bit storage patterns, is stored in pages of the flash memory.
